(19) United States
(12) Patent Application Publication
(10) Pub. No.: US 2012/0036217 A1
(43) Pub. Date: Feb. 9, 2012

(54) DATA CONVERSION DEVICE AND DATA CONVERSION METHOD

(75) Inventor: Yuji Nomura, Kawasaki (JP)

(73) Assignee: FUJITSU LIMITED, Kawasaki-shi (JP)

(21) Appl. No.: 13/020,400

(22) Filed: Feb. 3, 2011

(30) Foreign Application Priority Data
Feb. 5, 2010 (JP) 2010-024225

(51) Int. Cl. G06F 15/16

(52) U.S. Cl. 709/217

(57) ABSTRACT

A data conversion device includes a receiving unit which receives first data and first sequence information and second data and second sequence information that are transmitted from a first device to a second device, the first sequence information indicating that the first data is transmitted before the second data and the second sequence information indicating that the second data is transmitted after the first data, a transmitting unit that transmits the received first data and second data to a third device, and a control unit that instructs the transmitting unit to transmit the first data and the second data to the transmitting unit in accordance with a sequence indicated in the first sequence information and the second sequence information.

### CROSS-REFERENCE TO RELATED APPLICATION

This application is based upon and claims the benefit of priority of the prior Japanese Patent Application No. 2010-24225, filed on Feb. 5, 2010, the entire contents of which are incorporated herein by reference.

### FIELD

The present invention relates to a data conversion device and to a data conversion method.

### BACKGROUND

In software development, software being developed is tested to confirm that it can be correctly run on a computer. By performing such a test, it is possible to discover not only points for improvement in the software, but also points for improvement in the hardware.

Some points for improvement in the software and hardware cannot be found when the hardware runs the software for only a short time. Therefore, a computer is made to run the software for a long time in the test.

To run such tests, a device has been proposed which obtains data which is transmitted between computers along with the data acquisition sequence and the data acquisition time. The proposed device forwards the obtained data at communication intervals in accordance with the data acquisition sequence and data acquisition time to a computer different from the destination computer of the data.

Further, a device has been proposed which obtains data which is to transmitted between a client computer and a server, transmits the data to the client computer in place of the server, and test an application to be run on the client computer. The proposed device converts the data to change the originating address of the data to its own address, then transmits the data with the converted address to the client computer.

As related art, there are Japanese Laid-Open Patent Publication No. 2006-148358 and Japanese Laid-Open Patent Publication No. 2000-278359.

The test device has a CPU (Central Processing Unit) and a network interface for network connection use. The network interface has a buffer memory which stores the transmitted and received data and a control circuit which performs communication processing. The network interface, for example, when performing communication processing in accordance with the TCP (Transmission Control Protocol), performs processing to attach a sequence number showing the transmission sequence of data to the header part of data.

When the network interface receives data over the processing ability of the control circuit, packet loss occurs and sometimes the buffer memory stores data by a sequence different from the sequence number order. The CPU receives the data from the network interface in the sequence by which it was stored in the buffer memory and identifies the data acquisition sequence and acquisition time based on the same, so identifies the data acquisition sequence and acquisition time by a sequence different from the sequence number order, that is, the sequence of data stored in the buffer memory. If the test device transmits the data in accordance with this identified data acquisition sequence or acquisition time, the device under test will process the transmitted data by a sequence different from the data sequence of the data which was transmitted from the data source to destination, so the data processing by the device under test will be suspended.

### SUMMARY

The disclosed data conversion device has as its object to transmit data which has been transmitted from an originating device to a destination device to a device different from the destination device by the same sequence as the sequence of the data which has been transmitted to the destination device.

There is therefore provided a data conversion device comprising a receiving unit which receives first data and first sequence information and second data and second sequence information which are transmitted from a first device to a second device, in which the first data and the first sequence information and the second data and the second sequence information, the first sequence information showing that the first data was transmitted before the second data and the second sequence information showing that the second data was transmitted after the first data, a transmitting unit which transmits the received first data and second data to a third device, and a control unit which instructs the transmitting unit to transmit the first data and the second data to the transmitting unit in accordance with a sequence shown in the first sequence information and the second sequence information.

Additional objects and advantages of the invention (embodiment) will be set forth in part in the description which follows, and in part will be obvious from the description, or may be learned by practice of the invention. The object and advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF DRAWINGS

These and other objects and features will become clearer from the following description of the preferred embodiments given with reference to the attached drawings, wherein:

FIG. 1 is a view illustrating one example of a system configuration which a data conversion device can use;

FIG. 2 is a view illustrating a first example of a data conversion device;

FIG. 3 is a view explaining one example of connection between a receiving unit of a data conversion device and a communication device;

FIG. 4A is a view illustrating one example of a sequence of transmitted data between a client and an existing server;

FIG. 4B is a view illustrating one example of a sequence of transmitted data between the data conversion device and a test server;

FIG. 5 is a flow chart illustrating one example of data transmission control processing;

FIG. 6 is a view illustrating a second example of a data conversion device;

FIG. 7 is a flow chart illustrating one example of data transmission control processing;

FIG. 8 is a view illustrating one example of received information;

FIG. 9 is a view illustrating one example of transmission sequence information;

FIG. 10 is a view illustrating one example of a flow of processing illustrating one example of data transmission control processing;

FIG. 11 is a view illustrating one example of a flow of processing illustrating one example of data transmission control processing;

FIG. 12 is a view illustrating one example of the hardware configuration of the data conversion device;

FIG. 13A is a view illustrating one example of a communicating unit; and

FIG. 13B is a view illustrating one example of a communicating unit.

### DESCRIPTION OF EMBODIMENTS

Preferred embodiments of the data conversion device and data conversion method will be described in detail below while referring to the attached figures.

### System Configuration

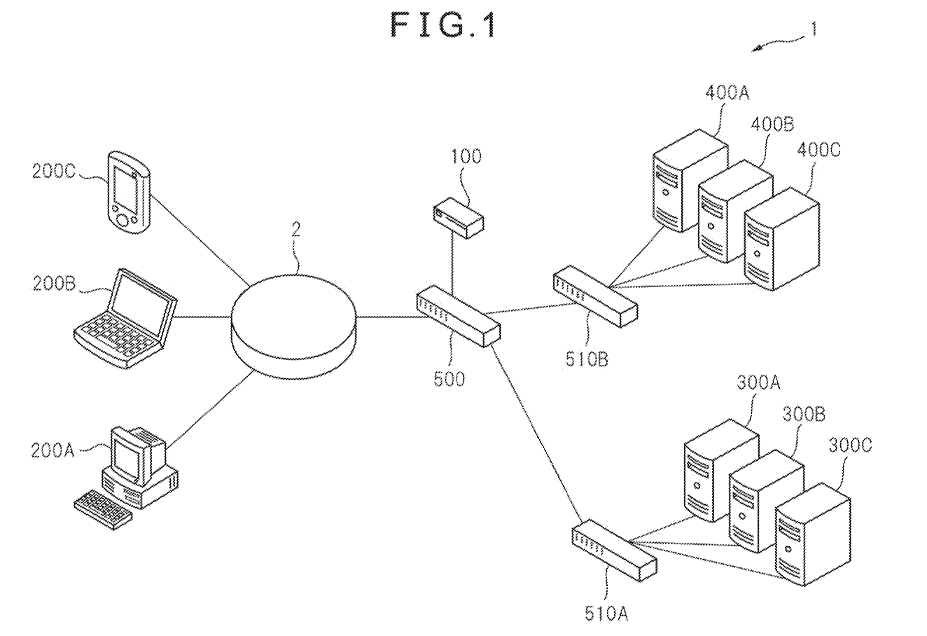

FIG. 1 is a view illustrating one example of the system configuration which a data conversion device 100 can use. The system configuration 1 illustrated in FIG. 1 has a network 2, a data conversion device 100, clients 200A to 200C, existing servers 300A to 300C, test servers 400A to 400C, a communication device 500, and communication devices 510A, 510B. The data conversion device 100, the existing servers 300A to 300C, and the test servers 400A to 400C are connected to the network 2 through the communication devices 500, 510A, 510B. The network 2 is a computer network, for example, a LAN (Local Area Network) or the Internet.

The numbers of the clients 200, existing servers 300, and test servers 400 illustrated in FIG. 1 are illustrations. The embodiments are not limited to the illustrated numbers. Further, in the following explanation, reference numeral 200 is deemed to indicate any of the clients 200A to 200C, 300 to indicate any of the existing servers 300A to 300C, and 400 to indicate any of the test servers 400A to 400C.

The client 200 is a data processing system requesting predetermined functions from the existing server 300, for example, is a desktop computer, laptop computer, or portable data terminal. The client 200 engages in data communication with the existing server 300 in accordance with a transmission control protocol. The transmission control protocol is, for example, the TCP (Transmission Control Protocol) or the UDP (User Datagram Protocol).

The existing server 300 is a data processing system which has a CPU (Central Processing Unit) and memory and uses the CPU to run software stored in the memory so as to provide the client 200 with predetermined functions. The existing server 300 is, for example, a data processing system which has finished being developed in terms of software and which has begun actual operation. The existing server 300 is a destination of transmission of data by the client 200 and communicates data with the client 200 in accordance with a transmission control protocol.

The test server 400 is a data processing system which has a CPU and memory and uses the CPU to run software stored in the memory so as to provide the client 200 with the same functions as the existing server 300. The test server 400 is, for example, a data processing system which is scheduled to provide services to the client 200 by running software after the software has finished being debugged and is a data processing system under test which runs software for a long period of time.

The test server 400 may be a data processing system which provides the same functions as the functions included in the existing server 300, but runs a program differing in computer language from the program included in the existing server 300. Alternatively, the test server 400 may be a data processing system which runs an application program the same as the existing server 300, but is of a type differing in OS (Operating System) and/or hardware. Further, the test server 400 may be a data processing system which runs an application program and OS the same as the existing server 300 together with virtualization software by hardware differing from the hardware of the existing server 300. The test server 400 may be designated by the data conversion device 100 as a destination of transmission of data and communicates data with the data conversion device 100 in accordance with the same transmission control protocol as with the existing server 300.

The data conversion device 100 is a data processing system which obtains the data which the client 200 transmits to the existing server 300 and transmits the obtained data to the test server 400 in place of the client 200. The data conversion device 100, may function as a test device which transmits data to the test server 400 for conducting a test on the test server 400 which runs software for a long period of time.

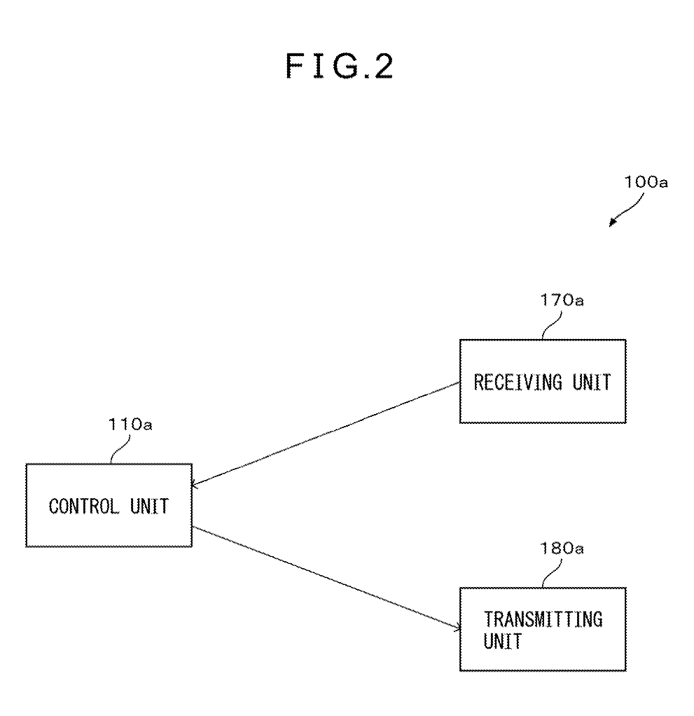

The data conversion device 100 further obtains the data which is sent from the existing server 300 to the client 200 and detects the sequence of the data transmission between the client 200 and the existing server 300. The data conversion device 100 runs data transmission control processing to control the sequence of data transmission to the test server 400 so that the sequence of the data transmission between the client 200 and the existing server 300 is also maintained between the data conversion device 100 and the test server 400. A detailed explanation of the data conversion device 100 will be given later using FIG. 2.

The address of the data which is transmitted from the client 200 is the existing server 300, so the data conversion device 100 converts the address of the data to the test server 400. The data conversion device 100 transmits data which is transmitted between the client 200 and the existing server 300 to the test server 400. The data conversion device 100 does not use simulated data and can run a test by transmitting data which is actually used over a long period, so it is possible to discover points for improvement in the software and the hardware before the test server 400 starts actual operation. Such points for improvement are, for example, stored in a log file, stored in the memory of the test server 400, containing time logs of details of processing and warnings of the application program, OS, and so on and are found after the test or during the test by referring to the log file.

The communication devices 500, 510A and 510B are devices which forward input data to the hardware at the forwarding destination of the data in accordance with the destination address. The destination address is, for example, an IP (Internet Protocol) address or MAC (Media Access Control) address. The communication devices 500, 510A, 510B are, for example, L3 (Layer 3) switches or L2 (Layer 2) switches.

The communication device 500 is connected to the data conversion device 100, the clients 200A to 200C, the existing servers 300A to 300C, and the test servers 400A to 400C.

The communication device 500 connects a port to which the client 200 is connected and a port to which the existing server 300 is connected so as to provide data communication between the client 200 and the existing server 300. The communication device 500 further connects a port to which the data conversion device 100 is connected and a port to which the test server 400 is connected to provide data communication between the data conversion device 100 and the test server 400.

Further, the communication device 500 performs an operation for copying the frames passing through the port connected to the client 200 or existing server 300 to a port to which the data conversion device 100 is connected. In this way, the communication device 500 can transmit data which has been transmitted between the client 200 and the existing server 300 to the data conversion device 100.

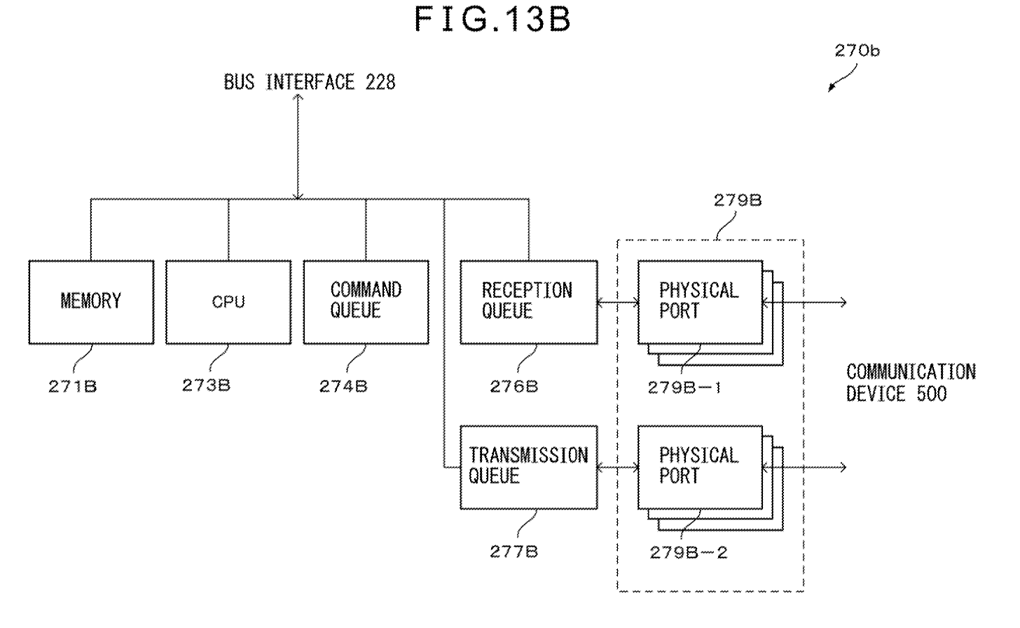

In FIG. 1, the communication device 500 and the data conversion device 100 are shown as separate hardware, but the communication device 500 and the data conversion device 100 may also be the same hardware. The functions and hardware configuration when the communication device 500 and the data conversion device 100 are the same will be explained later using FIG. 13B.

First Example of Data Conversion Device

Below, a first example of the data conversion device will be explained with reference to FIG. 2 to FIG. 5. FIG. 2 is a view illustrating a first example of the data conversion device 100. The first example of the data conversion device 100, that is, the data conversion device 100a, has a control unit 110, a receiving unit 170a, and a transmitting unit 180a.

First Example of Data Conversion Device: Transmission Unit

The transmitting unit 180a performs processing to transmit data instructed by the control unit 110 to the test server 400.

First Example of Data Conversion Device: Reception Unit

The receiving unit 170a receives data which has been transmitted from the client 200 to the existing server 300 and data which has been transmitted from the test server 400. The receiving unit 170a performs processing to transmit the received data to the control unit 110a.

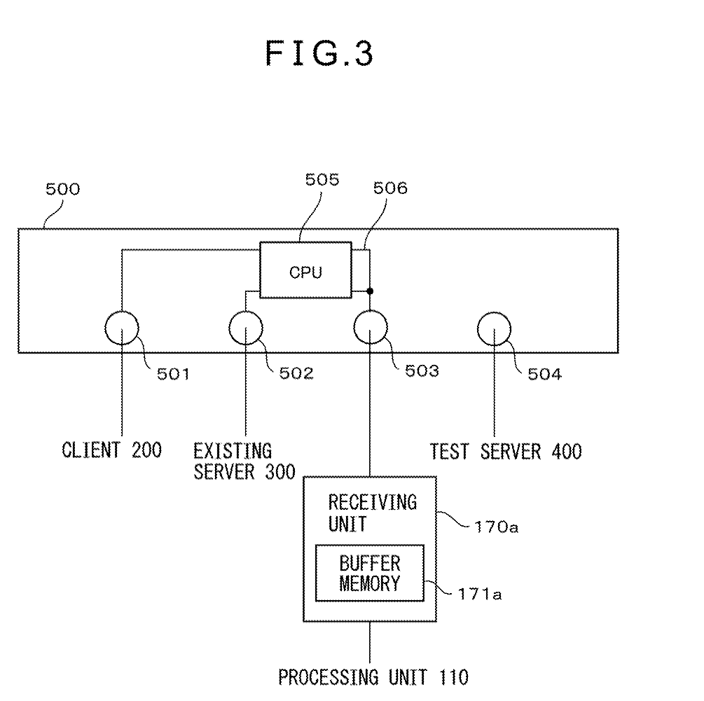

FIG. 3 is a view for explaining one example of the connections between the receiving unit of the data conversion device and the communication device. The communication device 500 has a physical port 501 which is connected to the client 200, a physical port 502 which is connected to the existing server 300, a physical port 503 which is connected to the receiving unit 170a of the data conversion device 100, a physical port 504 which is connected to the test server 400, and a CPU 505. The CPU 505 copies frames passing through the physical ports 501 and 502 which are connected to the client 200 and the existing server 300 and transmits them through a connection line 506 to the physical port 503 to which the data conversion device 100 is connected. In the following, the above copying operation will be referred to as “port mirroring”. The buffer memory 171a of the receiving unit 170a stores data in the sequence by which the data was received at the physical port 503, while the receiving unit 170a transmits the data which was stored in the buffer memory 171a to the control unit 110a. In this way, the communication device 500 can transmit the data which is transmitted between the client 200 and the existing server 300 to the data conversion device 100.

However, sometimes the data is not transmitted to the physical port 503 by the sequence by which data was received at the physical ports 501 and 502. Such inversion of the data sequence may occur, for example, under the following circumstances.

(1) An abnormality occurs in the processing of port mirroring of the CPU 505 and the sequence by which data is received at the physical ports 501 and 502 becomes different.
(2) The CPU 505 sends high priority succeeding data received at the physical ports 501 and 502 to the physical port 503 before the low priority preceding data.

The data which the receiving unit 170a received by a sequence different from the sequence by which data was received at the physical ports 501, 502, as explained later, is processed by the control unit 110a to change the sequence of the received data and restore it to the sequence by which data was received at the physical ports 501 and 502.

### First Example of Data Conversion Device: Control Unit

The control unit 110a of FIG. 2 runs data transmission control processing for controlling the transmission sequence of the data so that data which was transmitted from the client 200 to the existing server 300 is transmitted to the test server 400 by the sequence of the data which was transmitted between the client 200 and the existing server 300.

The control unit 110a further runs address conversion processing for converting the destination address of data which is transmitted from the client 200 to the existing server 300 to the test server 400 and changing the address showing the source of the data from the client 200 to the data conversion device 100.

### First Example of Data Conversion Device: Example of Inversion of Data Sequence

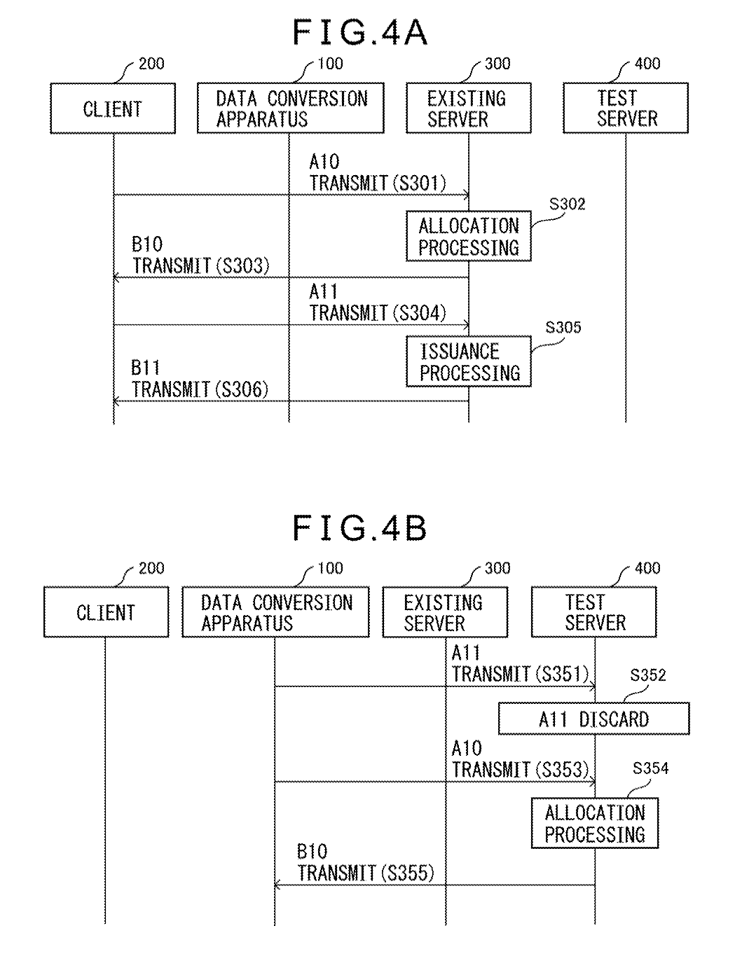

If the transmission sequence of the data which the data conversion device 100 transmits to the test server 400 and the transmission sequence of the data which the client 200 transmits to the existing server 300 differ, unanticipated issues will appear in the test server 400. FIG. 4A and FIG. 4B will be used to explain one example where the sequence of data transmitted to the existing server and data transmitted to the test server do not match. FIG. 4A is a view illustrating one example of a sequence of transmission data between a client and an existing server. FIG. 4B is a view illustrating one example of a sequence of transmission data between the data conversion device and a test server.

In the example illustrated in FIG. 4A, the existing server 300 runs an e-trade service. First, the client 200 transmits a request for purchase of a product Z, that is, data A10, to the existing server 300 to request the e-trade service provided by the existing server 300 (S301). The existing server 300 receives a bid for the product Z included in the data A10 from the client 200 and, if the bid is higher than a bid received from another client, executes processing to allocate the product to the client 200 (S302). The existing server 300, as a response to the request from the client, transmits to the client 200 data B10 which notifies the client 200 that the product Z can be purchased (S303).

The client 200 transmits the data A11 to the existing server 300 to thereby transmit a request for purchase of the product Z to the existing server 300 (S304). The existing server 300 confirms the allocation of the product Z to the client 200 and executes processing to issue the product to the client 200 (S305), then transmits data B11, which notifies the client 200 of the issuance of the product, to the client 200 (S306).

The data which is transmitted at the above S301, S303, S304, and S306 is obtained by the data conversion device 100 through the receiving unit 170a.

FIG. 4B illustrates one example of an e-trade service run by the test server 400. FIG. 4B illustrates an example of the case where the data conversion device 100 does not perform data transmission control processing for controlling the transmission sequence of the data. When the data is sent to the test server 400 in a transmission sequence different from the transmission sequence of data to the existing server 300, the data conversion device 100 sends not the data A10, but the data A11 (S351). In such a case, the test server 400 receives the bid for the product Z from the client 200 in the state not having finished allocating the product Z to the client 200. Therefore, the transmitted A11 is discarded (S352). After that, the data conversion device 100 serving as the client 200 transmits the data A10 of the request for purchase of the product Z to the existing server 300 (S353) so as to request the e-trade service provided by the test server 400 (S354). The test server 400 receives from the client 200 the bid for the product Z included in the data A10 and, if the bid is higher than a bit received from another client, performs processing to allocate the product to the client 200 (S354). The test server 400 transmits the data B10 which notifies the client 200 that the product Z is available for purchase to the data conversion device 100 serving as the client 200 (S355). After that, the test server 400 waits for the data A11 from the client 200 requesting purchase of the product Z, but this was already transmitted at S351, so the test server 400 does not receive the data A11 and the processing of the test server 400 is suspended.

As illustrated in the above example, the test server 400 is sent data by a transmission sequence different from the transmission sequence of data to the existing server 300, so the test of whether the test server 400 can run processing the same as the existing server 300 is suspended.

To avoid such points for improvement relating to the data transmission sequence, the control unit 110a transmits the data which is transmitted from the client 200 to the existing server 300 to the test server 400 by the sequence by which it is transmitted between the client 200 and the existing server 300. Below, one example of the data transmission control processing will be explained.

First Example of Data Conversion Device: Data Transmission Control Processing

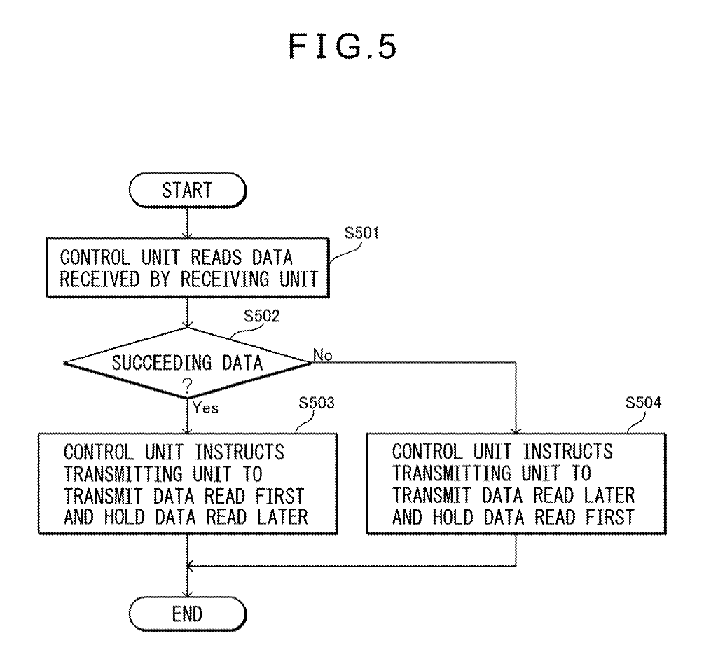

FIG. 5 is a flowchart illustrating one example of data transmission control processing. First, the control unit 110a reads data from the receiving unit 170a (S501). The control unit 110a judges if the read data is succeeding data of data which the control unit 110a previously read from the receiving unit 170a (S502). At S502, for example, it is possible to judge whether the sequence information of data which was read at S501 indicates continuation of sequence information of data which was previously read from the receiving unit 170a. The sequence information is the sequence number at the header part of data when, for example, the data is sent in accordance with the TCP. Further, the sequence information is the sequence number at the body of the data when, for example, the data is sent in accordance with the UDP.

When the read data is a continuation of data which was previously read from the receiving unit 170a (S502, Yes), the control unit 110a instructs the transmitting unit 180a to transmit the data which was previously read and holds the data which was currently read (S503). When the read data is not a continuation of the data which was previously read from the receiving unit 170a (S502, No), the control unit 110a instructs the transmitting unit 180a to transmit the data which was currently read and holds the data which was previously read (S504). In the data transmission at S503 and S504, the control unit 110a runs the address conversion processing to change the source from the client 200 to the data conversion device 100, change the destination from the existing server 300 to the test server 400, and sends the resultant data to the transmitting unit 180b.

Thus, the control unit 110a uses the sequence information of the data to control the transmission of data, so the data conversion device 100 can transmit the data, transmitted from the client 200, to the test server 400 in the same sequence as the transmission sequence from the client 200 to the existing server 300. As explained using FIG. 3, inversion of the data sequence can occur, for example, due to port mirroring or data priority control. However, the sequence information of the data is prepared by the source, that is, the client 200 and the sequence information itself of the data remains unchanged. Therefore, by transmitting the data in accordance with the sequence information of the data rather than the sequence by which the control unit 110a received the data, it is possible to transmit the data to the test server 400 in the same sequence as the sequence of the data which was transmitted to the existing server 300.

Second Example of Data Conversion Device

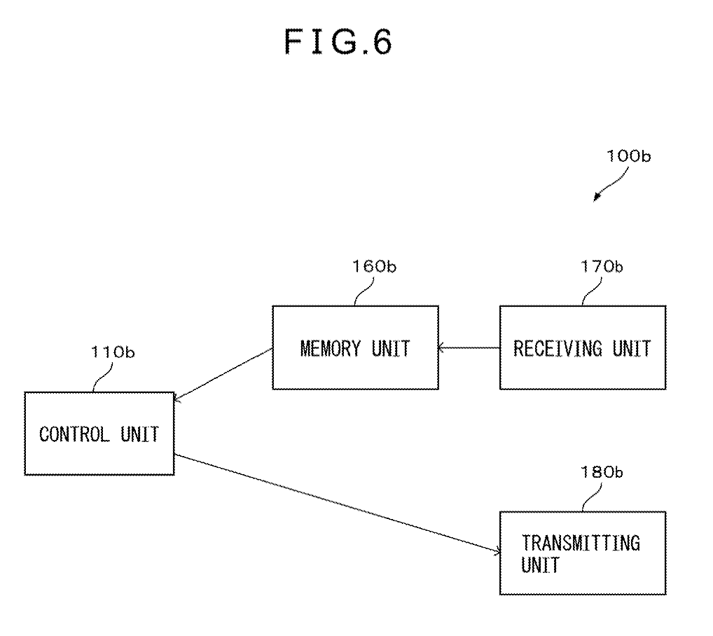

FIG. 6 is a view illustrating a second example of the data conversion device. The data conversion device 100b according to the second example illustrated in FIG. 6 has a storage unit 160b in addition to the data conversion device 100a which is illustrated in FIG. 2. The storage unit 160b stores the later explained received information 310 and transmission sequence information 330. The control unit 110b executes not only the address conversion processing and data transmission control processing which the control unit 110a executes, but also processing for writing data into information stored in the storage unit 160b. The receiving unit 170b and the transmitting unit 180b perform operations similar to the receiving unit 170a and transmitting unit 180b illustrated in FIG. 2. Below, the second example of the data conversion device will be explained using FIG. 6 to FIG. 9.

### Second Example of Data Conversion Device: Data Transmission Control Processing

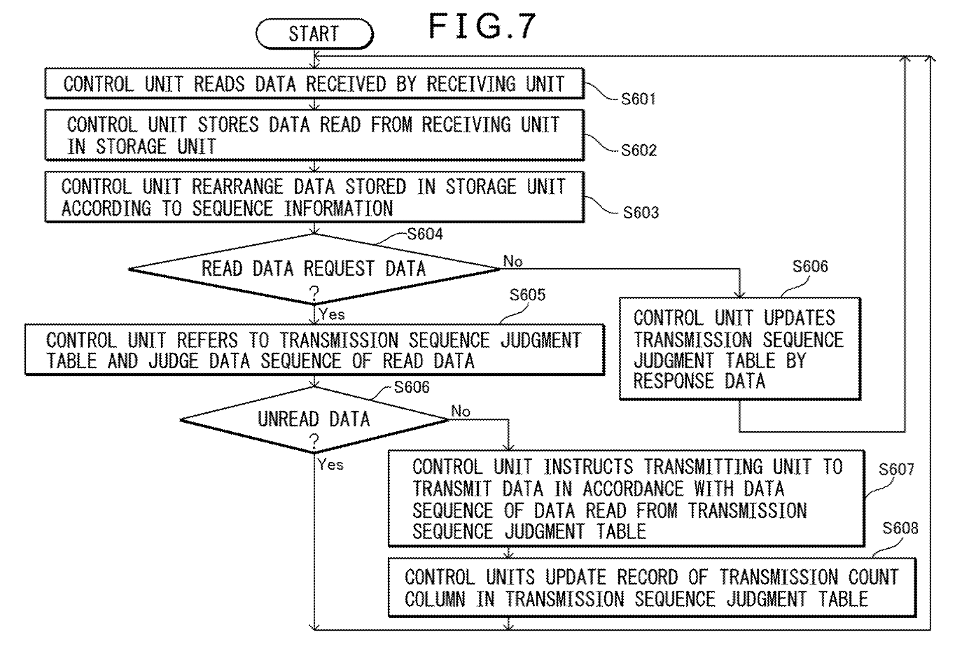

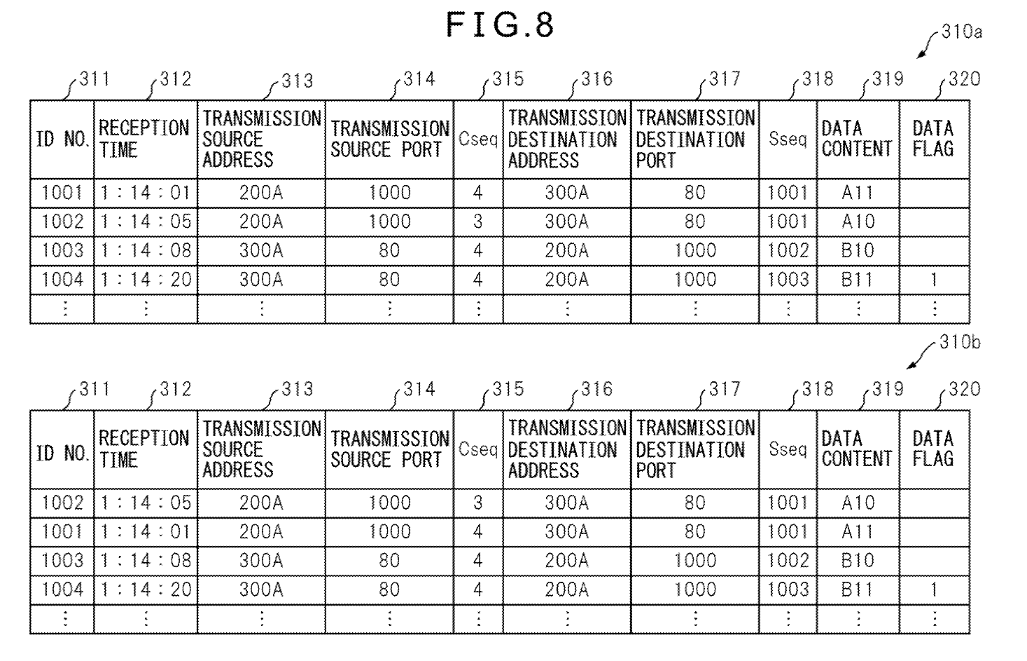

FIG. 7 is a flowchart illustrating one example of data transmission control processing by the data conversion device of FIG. 6. First, the control unit 110b reads the data which the receiving unit 170b received (S601). The control unit 110b stores the data which the receiving unit 170b received at the storage unit 160b (S602). The control unit 110b, for example, stores received data as the received information 310 illustrated in FIG. 8 in the storage unit 160b. The received information 310 will be explained below.

### Second Example of Data Conversion Device: Data Transmission Control Processing (Received Information)

FIG. 8 is a view illustrating one example of the received information. The received information 310a illustrated in FIG. 8 includes an ID number column 311, a reception time column 312, a transmission source address column 313, a transmission source port column 314, a client side sequence number (Cseq) column 315, and a transmission destination address column 316. The received information 310a further includes a transmission destination port column 317, a server side sequence number (Sseq) column 318, a data content column 319, and a data flag column 320.

The ID number of the ID number column 311 is a number for identifying each of the entries of the received data arranged in ascending order of the reception time. The received time column 312 is the time at which data was received by the control unit 110b from the receiving unit 170b. The transmission source address column 313 and transmission source port column 314 respectively register the address and the port number of the client 200 originating transmission of data. The transmission destination address column 316 and transmission destination port column 317 respectively register the address and port number of the existing server 300 originating transmission of data. Note that, in this Specification and in the drawings, the transmission source address and transmission destination address are shown by the reference notations.

The client side sequence number column 315 registers the sequence number transmitted from the client 200, while the server side sequence number column 318 registers the sequence number transmitted from the existing server 300. When the client 200 and the server establish a connection, a communication path is formed between the client 200 and the server. For example, in the TCP, to realize byte unit streaming type communication on a communication path, the “sequence number” determining the byte positions is sent for the byte data flowing over the communication path. In the example of the TCP, the sequence number is, for example, a 32-bit sign-less integer. In the example illustrated in FIG. 8, the sequence number is shown by decimal notation. The data flag column 320 stores data flags identifying if data is being processed by the control unit 110b. At the data content column 319, “A” indicates “request data” and “B” indicates “response data”. The data flag column 320, for example, is set with “1” in the case of the data which was read out by S601 and is not set with “1” for data which was read first. The method of use of the data flag column 320 will be explained later at S605.

After the S602 illustrated in FIG. 7, the control unit 110b rearranges the data which is stored in the storage unit 160b by the sequence information (S603). The received information 310b illustrated in FIG. 8 is obtained by rearranging the received information 310a according to the sequence information at S502. At the received information 310a, the sequence number in the client side sequence number column 315 at the entry of the ID number 1001 is “4”, while the sequence number in the client side sequence number column 315 at the entry of the ID number 1002 is “3”. Therefore, the control unit 110b rearranges the sequence numbers in ascending order and, as illustrated by the received information 310b, inverts the sequence of the entry identified by the ID number 1001 and the entry identified by the ID number 1002.

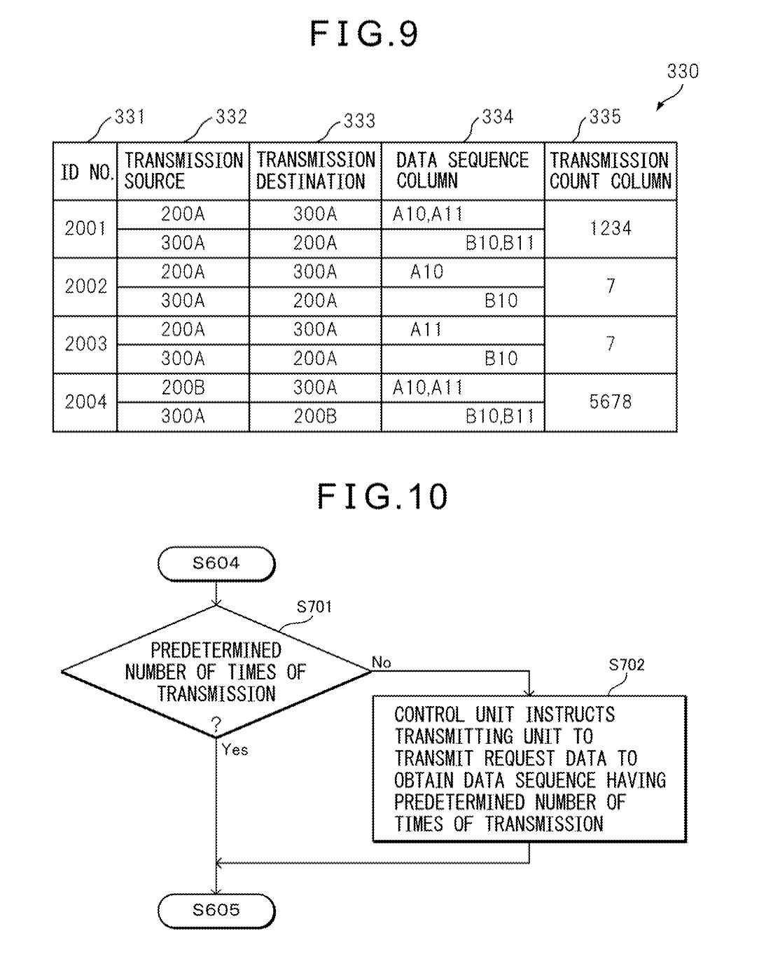

After S603 illustrated in FIG. 7, the control unit 110b judges if the data which was read at S601 is the request data (S604). If the read data is not the request data (S604, No), the control unit 110b updates the transmission sequence information 330 illustrated in FIG. 9 as the response data (S606).

### Second Example of Data Conversion Device: Data Transmission Control Processing (Transmission Sequence Information)

FIG. 9 is a view illustrating one example of transmission sequence information. The transmission sequence information 330 illustrated in FIG. 9 includes an ID number column 331, a transmission source address column 332, a transmission destination address column 333, a data sequence column 334, a transmission count column 335.

The data sequence column 334 registers the sequence of data including the data received at S601. A10 and A11 illustrated in the data sequence column 334 are the request data, while B10 and B11 are the response data, as illustrated in the data content column 319 in FIG. 8. Whether data is request data can, for example, be determined by, a “get request” at the data part of the TCP, while whether data is response data can, for example, be determined by a “get response” at the data part of the TCP. Thus, the control unit 110b analyzes the data part and determines if the transmitted data is request data or response data.

In the transmission sequence information 330, as illustrated in the data sequence column 334, entries are provided for sets of the request data and the response data.

The ID number of the ID number column 331 is a number for identifying the sequence of the data received. The transmission source address column 332 registers the address of the data transmission source, that is, the client 200 or the existing server 300. The transmission destination address column 333 registers the address of the client 200 or the existing server 300. Note that, the data sequence column registers four data in the data sequence shown for the ID no. 2001 and registers two data in the data sequence shown for the ID no. 2002, but the embodiment is not limited to these numbers of data. The transmission count column 335 registers the number of times when a data sequence identified by an ID number was sent.

After S606 illustrated in FIG. 7, the control unit 110b again performs S601. If the read data is request data (S604, Yes), the control unit 110b refers to the transmission sequence information 330 and judges the data sequence of the read data (S605). For example, when the transmission source of the currently read data is the client “200A”, the transmission destination is “300A”, and the data is “A11”, the ID number 2001 or 2003 illustrated in FIG. 9 may be the corresponding data sequence. The control unit 110b refers to the transmission count column 335 for the ID numbers 2001 and 2003 to find that the number of times of transmission “1234” of the data sequence of the ID number “2001” is greater than the number of times of transmission “7” of the data sequence of the ID number “2003”. Accordingly, the control unit 110b judges that the data “A11” is the data which is transmitted by the sequence of “A10”→“A11”→“B10”→“B11”.

When there is still data which is not read out in the data transmission sequence selected at S605 in FIG. 7 (S606, Yes), the control unit 110b returns again to S601, then reads the succeeding data. When “A10” is read before the request data “A11” according to the selected data transmission sequence, the routine waits for the response data “B10, B11” after the “A11”, but when the request data “A10” is not read out, the routine waits for reading of data of the read request data “A10”. This processing is performed since sometimes the reception of the request data “A10” is delayed.

When there is no data not yet read in the data transmission sequence selected at S605 (S606, No), the control unit 110b instructs the transmitting unit 180a to transmit the data according to the selected data transmission sequence (S607). At S607, the control unit 110a may also execute the address conversion processing to change the transmission source from the client 200 to the data conversion device 100, change the transmission destination from the existing server 300 to the test server 400, and send the resultant data to the transmitting unit 180b. After transmitting the data, the control unit 110b updates the record in the transmission count column 335 of the transmission sequence information (S608).

When there is data which is not yet read in the selected data transmission sequence (S606, Yes), the control unit 110b returns again to S601 and executes the read processing. When there is no information for identifying the sequence in the data, the control unit 110b can execute the above data transmission control processing without performing S603.

The data conversion device 100 can use the actual information of the data transmission sequence to determine the data transmission sequence and transmit data to the test server. The control unit 110a can use the sequence information of data to control the transmission of data, and therefore the data conversion device 100 can transmit the data, transmitted from the client 200, to the test server 400 in the same sequence as the sequence of transmission from the client 200 to the existing server 300.

At S605 in the second example of the data conversion device, the explanation was given of the case where the transmission source of the currently read data, for example, was the client 200A and the data was “A11”. In the second example, the transmission count column 335 of the transmission sequence information 330 is referred to and it is determined that the transmission count was the greatest for the entry in the data sequence column indicated by the ID number “2001”. However, there may be the case where there is no data illustrated at the ID number “2001”.

In this case, at S605, the control unit 110b judges if the entry in the data sequence column corresponding to the greatest transmission count among the entries in the data sequence column of data with the same transmission destination is the data sequence of the read data. For example, when the transmission destination of the currently read data is “300A” and the read data is “A11”, the ID numbers 2003 or 2004 illustrated in FIG. 9 indicates the corresponding data sequence. Information of a data sequence column with the same transmission destination, but a different transmission source is used because the existing server 300 of the transmission destination can respond by the same data sequence if the request is the same.

The control unit 110b refers to the transmission count information 335 of the ID numbers 2003, and 2004 and find that the number of times of transmission “5678” of the data sequence of the ID number “2004” is greater than the number of times of transmission “7” of the data sequence of the ID numbers “2003”. Accordingly, the control unit 110b judges that the data “A11” is the data which is transmitted by the sequence of “A10”→“A11”→“B10”→“B11”.

Even when there is no actual information on the transmission source, the data conversion device 100 can use the record of the data transmission sequence of another transmission source to determine the data transmission sequence and transmit the data.

### Third Example of Data Conversion Device: Data Transmission Control Processing

According to the third example of the data conversion device, the data conversion device 100 executes processing for registering data in the transmission sequence information 330 between S604 and S605 in the second example FIG. 7. The rest of the operations of the control unit 110b are the same as the operations explained in the second example.

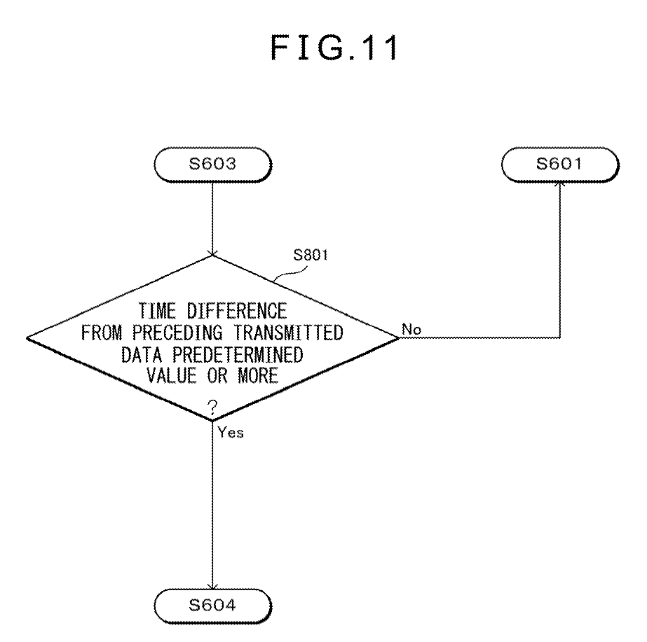

FIG. 10 illustrates one example of the data transmission control processing performed by the control unit 110b between S604 and S605. The control unit 110b judges if there is a predetermined transmission count in the transmission count column of the transmission sequence information 330 (S701). A “predetermined transmission count” means the number of times of transmission required for judging the data sequence at S605. If there is not the predetermined transmission count in the transmission count column of the transmission sequence information 330 (S701, No), the control unit 110b instructs the transmitting unit 180b to transmit the request data to the test server 400 so that the control unit obtains the data sequence transmitted the predetermined number of times (S702). At S702, for example, to obtain the data shown by the ID numbers “2001” and “2003” of the transmission sequence information 330 illustrated in FIG. 9, the data conversion device 100 continuously transmits the request data “A10” and “A11”.

If there is a predetermined count of transmissions at the transmission count column of the transmission sequence information 330 (S701, Yes), the control unit 110b executes S605.

Thus, when there is no actual information on the data transmission sequence, the data conversion device 100 can take the place of the client 200 and transmit the request data to the test server 400 so as to prepare transmission sequence information 330 and thereby judge the past record of the data transmission sequence.

Fourth Example of Data Conversion Device: Data Transmission Control Processing

According to the fourth example of the data conversion device, the data conversion device 100 executes processing for registering data at the transmission sequence information 330 between S604 and S605 of the second example. The rest of the operations of the control unit 110b are the same as the operations explained in the second example.

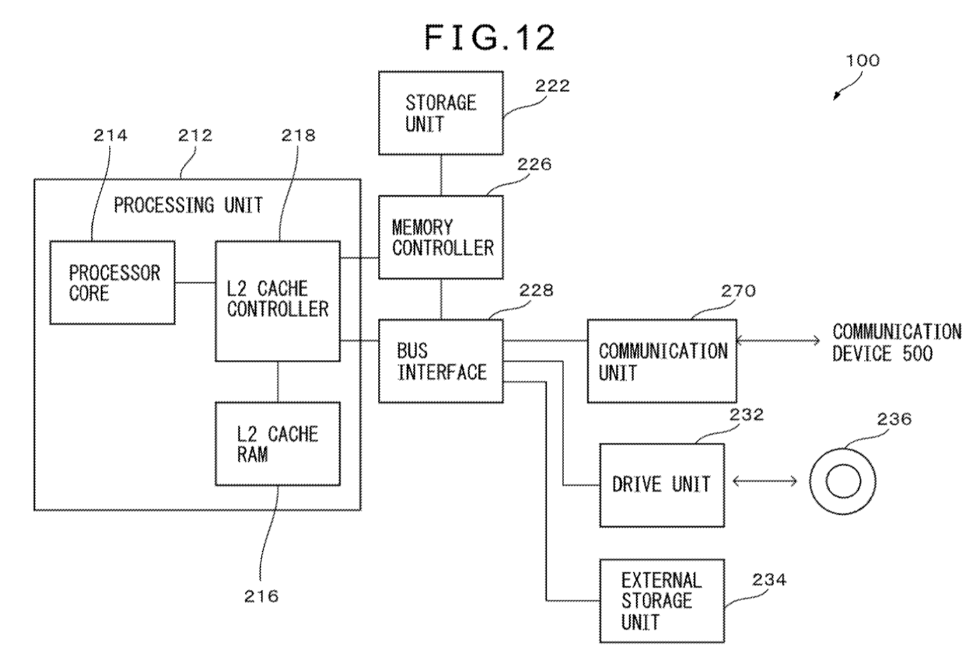

FIG. 11 shows an example of the data transmission control processing performed by the control unit 110b between S603 and S604. The control unit 110b judges if the time difference between the reception time of the read data and the reception time of the preceding transmitted data is a predetermined value or more (S801). If longer than the predetermined value (S801, Yes), there is a high possibility of inversion of the sequence of data occurring, so the control unit 110b executes the data transmission control processing of S604 on. When shorter than the predetermined value (S801, No), there is a low possibility of the sequence of data being inverted, so the control unit 110b returns to S601. Note that, the control unit 110b can judge the reception time at S801 by referring to the reception time in the received information 310.

The data conversion device 100 can prevent the data transmission control processing from being performed under certain conditions and thereby reduce the processing load of the data conversion device 100.

Hardware Configuration of Data Conversion Device

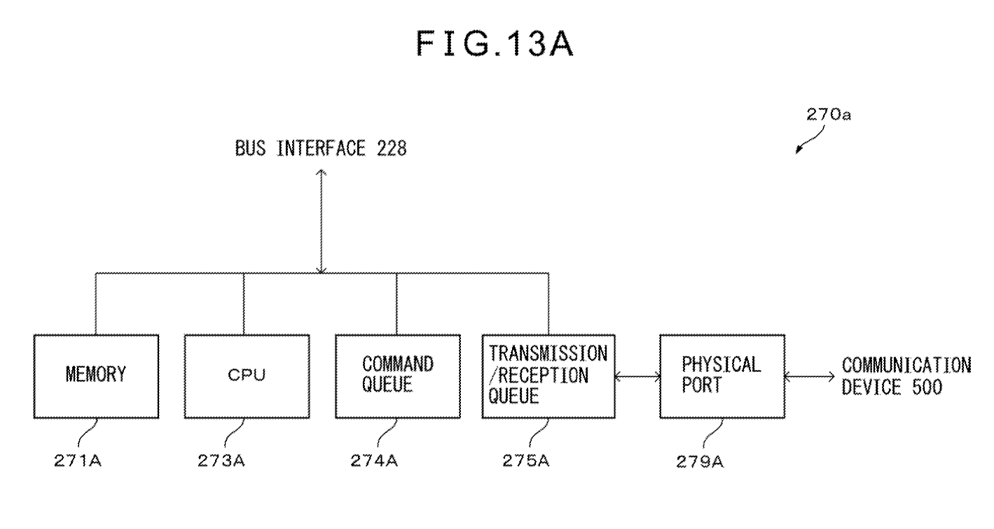

FIG. 12 is a view illustrating an example of the hardware configuration of the data conversion device 100. The data conversion device 100 illustrated in FIG. 12 has a processing unit 212, a storage unit 222, a memory controller 226, a bus interface 228, a drive unit 232, an external storage unit 234, and a communication unit 270.

The processing unit 212 has a processor core 214, an L2 cache (secondary cache) RAM (Random Access Memory) 216, and an L2 cache controller 218 which controls the L2 cache RAM 216. The processing unit 212 connects to the storage unit 222 through the memory controller 226. Further, the processing unit 212 connects through the bus interface 228 to the drive unit 232, the external storage unit 234, and the communication unit 270.

The L2 cache RAM 216 stores part of the content stored in the storage unit 222 in accordance with an instruction from the processor core 214. The L2 cache RAM 216 is, for example, an SRAM (Static Random Access Memory).

The processor core 214 reads out data or instructions from the L2 cache RAM 216, processes data in accordance with the instructions, and stores the processed results in the L2 cache RAM 216 or storage unit 222. The instructions or data are stored as a program 900 in the storage unit 222. The processing unit 212 may for be a multi-core processor carrying a plurality of processor cores 214. The processing unit 212 is, for example, a CPU.

The processing unit 212 runs the program 900 so as to realize the functions of the control unit 110 explained in FIG. 2 and operate as the control unit 110a explained in FIG. 2 or the control unit 110b explained in FIG. 6.

The memory controller 226 receives a load instruction from the processing unit 212 or bus interface 228, loads data or instructions from the storage unit 222, and outputs the same to the processing unit 212 or bus interface 228. The memory controller 226, further, receives a store instruction and data covered from the processing unit 212 or bus interface 228 and stores the received data in the storage unit 222.

The storage unit 222 is a storage device comprised of a semiconductor device, for example, is a DRAM (Dynamic Random Access Memory). The external storage unit 234 is a storage device with a larger storage capacity than the storage unit 222 and from which data will not be lost even if not supplied with power, for example, is a disk array having magnetic disks or SSD (Solid State Drive) using a flash memory. The external storage unit 234 can store instructions, data, and programs stored in the storage unit 222.

The bus interface 228 is a bus connecting the processing unit 212 and other connection devices. The bus interface 228 is, for example, a circuit functioning in accordance with the specifications of the AGP (Accelerated Graphics Port) or PCI Express (Peripheral Component Interconnect Express) etc.

The drive unit 232 is, for example, a device which reads and writes data into a floppy disk or CD-ROM, DVD, or other storage medium 236. The drive unit 232 includes a motor which turns the storage medium 236 or a head which reads or writes data from and to the storage medium 236. Note that, the storage medium 236 can store the program 900. The drive unit 232 reads out the program 900 from the storage medium 236 set at the drive unit 232. The processing unit 212 stores the program read out by the drive unit 232 in the storage unit 222 and/or external storage unit 234.

The communication unit 270 is a device which is connected to a network and is used for communicating with data processing systems connected to the network. As illustrated in FIG. 1, the communication unit 270 connects the communication device 500 with the network. The communication unit 270 is, for example, an NIC (Network Interface Controller).

The communication unit 270, for example, can operate as a receiving unit 170a and a transmitting unit 180a illustrated in FIG. 2 or can operate as a receiving unit 170b and transmitting unit 180b illustrated in FIG. 6.

Communication Unit Case where Data Conversion Device is Separate Hardware from Communication Device

FIG. 13A is a view illustrating one example of a communication unit of the data conversion device 100 in the case where the data conversion device 100 is separate hardware from the communication device 500. The communication unit 270a illustrated in FIG. 13A is one example of a communication unit 270 illustrated in FIG. 12. The communication unit 270a has a memory 271A, a CPU 273A, a command queue 274A, and transmission/reception queue 275A and a physical port 279A. The command queue 274A holds commands forwarded from the processing unit 212. In the commands, the IP addresses or MAC addresses etc. of the forwarding destinations of the data forwarding operations are identified.

The CPU 273A runs a communication program stored in the memory 271A to realize a communication processing function in accordance with a predetermined protocol. The predetermined protocol is, for example, the protocol defined for the Ethernet® or TCP/IP (Transmission Control Protocol/Internet Protocol). The communication processing function realized by the CPU 273A reads a command held by the command queue 274A, then the CPU 273A obtains data from a position of the storage unit 222 identified by the memory address contained in the command and forwards the obtained data to the test server 400. Further, the CPU 273A obtains the data held in the transmission/reception queue 275A and commands identifying the data and stores the data at positions of the storage unit 222 identified by the memory addresses contained in the commands.

The physical port 279A is connected to a network cable and performs input/output of data to and from the network cable. The transmission/reception queue 275A holds data which had been transmitted from the test server 400 to the physical port 279A or holds data which the test server 400 will transmit and outputs the same to the physical port 279A.

Communication Unit: Case where Data Conversion Device is Hardware Same as Communication Device

FIG. 13B is a view illustrating one example of a communication unit of the data conversion device 100 in the case where the data conversion device 100 is the same hardware as the communication device 500. The communication unit 270a illustrated in FIG. 13B is one example of a communication unit 270 illustrated in FIG. 12. The communication unit 270b illustrated in FIG. 13B illustrates the configuration when, since the data conversion device 100 includes the communication device 500, the communication unit 270 included in the data conversion device 100 operates as the communication device 500. The communication unit 270b has a memory 271B, a CPU 273B, a command queue 274B, a reception queue 276B, a transmission queue 277B, and physical ports 279B. The memory 271B and command queue 274B operate in the same way as the memory 271A and the command queue 274A included in the communication unit 270a illustrated in FIG. 13A, so the explanations of these devices will be omitted.

The physical ports 279B consist of a plurality of physical ports connected to a plurality of network cables and input and output data to and from the network. For example, the physical port 279B-1 operates as a reception use physical port and receives as input data transmitted from the client 200. The input data is held at the reception queue 276B. The physical port 279B-2 operates as a transmission use physical port and outputs data which is to be transmitted to the existing server 300 and the test server 400. The data to be transmitted is held in the transmission queue 277B.

The memory 271B stores a routing table including information linking the physical ports, IP addresses, and/or MAC (Media Access Control) addresses. The CPU 273B, like the CPU 273A, runs the communication program stored in the memory 271B so as to realize a communication processing function according to a predetermined protocol and runs routing processing referring to the routing table. The “routing processing”, for example, refers to the routing table to investigate the previous address of the data received from a certain reception use physical port 279B-1 and sends out the received data to the corresponding transmission use physical port 279B-2.

The CPU 273B reads a command which is held at the command queue 274B, obtains data from a position of the storage unit 222 identified by a memory address contained in the command, and forwards the obtained data to the test server 400. Further, the CPU 273B obtains the data which is held at the reception queue 276B and a command which is held at the command queue 274B, and stores data at a position of the storage unit 222 identified by the memory address contained in the command.

Further, any of the physical ports 279B-1 and 279B-2 may correspond to the port 503 explained in FIG. 3. The CPU 273B performs the “port mirroring” which was explained using FIG. 3 and stores the data received at the physical port corresponding to the port 503 at the reception queue 276B.

All examples and conditional language recited herein after intended for pedagogical purposes to aid the reader in understanding the principles of the invention and the concepts contributed by the inventor to furthering the art and are to be construed as being without limitation to such specifically recited examples and conditions. Neither does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A data conversion device comprising
a receiving unit that receives first data and first sequence information and second data and second sequence information that are transmitted from a first device to a second device, the first sequence information indicating that the first data is transmitted before the second data and the second sequence information indicating that the second data is transmitted after the first data;
a transmitting unit that transmits the first data and the second data to a third device; and
a control unit that instructs the transmitting unit to transmit the first data and the second data from the transmitting unit in accordance with a sequence indicated by the first sequence information and the second sequence information.

2. The data conversion device according to claim 1, wherein
the receiving unit receives third data and fourth data that are transmitted from the first device to the second device, the first data and the third data being requests for obtaining fifth data stored in the third device, and the second data and the fourth data being requests for obtaining sixth data stored in the third device, and
the control unit further judges a reception sequence of the third data and the fourth data and instructs the transmitting unit to transmit the first data and the second data in accordance with the reception sequence.

3. The data conversion device according to claim 1 or 2, wherein
the receiving unit receives third data and fourth data that are transmitted from the first device to the second device, the first data and the third data being requests for obtaining fifth data stored in the third device, and the second data and the fourth data being requests for obtaining sixth data stored in the third device, and
the control unit instructs transmission of the third data and the fourth data to the control unit according to a first transmission sequence that transmits the third data before the fourth data, instructs transmission of the third data and the fourth data to the control unit according to a second transmission sequence that transmits the fourth data before the third data, and, when there is a response to transmission according to the first transmission sequence or the second transmission sequence from the third device, instructs transmission of the first data and the second data to the transmitting unit according to the first transmission sequence or second transmission sequence corresponding to the response.

4. A data conversion method comprising:
receiving, by a receiving unit, first data and first sequence information, and second data and second sequence information that are transmitted from a first device to a second device, the first sequence information indicating that the first data is transmitted before the second data and the second sequence information indicating that the second data is transmitted after the first data;
instructing, by a control unit, the transmitting unit to transmit the first data and the second data to the transmitting unit in accordance with a sequence indicated in the first sequence information and the second sequence information; and
transmitting, by a transmitting unit, the received first data and second data to a third device.

5. The data conversion method according to claim 4, the method further comprising
receiving, by the receiving unit, third data and fourth data that are transmitted from the first device to the second device, the first data and the third data being requests for obtaining fifth data stored in the third device, and the second data and the fourth data being requests for obtaining sixth data stored in the third device, and
judging, by the control unit, a reception sequence of the third data and the fourth data and instruct the transmitting unit to transmit the first data and the second data in accordance with the reception sequence.

6. The data conversion method according to claim 4 or 5, the method further comprising:
receiving, by the receiving unit, third data and fourth data that are transmitted from the first device to the second device, the first data and the third data being requests for obtaining fifth data stored in the third device, and the second data and the fourth data being requests for obtaining sixth data stored in the third device, and
instructing, by the control unit, transmission of the third data and the fourth data to the control unit according to a first transmission sequence that transmits the third data before the fourth data, instructing transmission of the third data and the fourth data to the control unit according to a second transmission sequence that transmits the fourth data before the third data, and, when there is a response to transmission according to the first transmission sequence or the second transmission sequence from the third device, instructing transmission of the first data and the second data to the transmitting unit by the first transmission sequence or second transmission sequence corresponding to the response.

7. A non-transitory storage device storing a program having a data conversion device including a receiving unit, a transmitting unit, and a control unit convert data, the program comprising:
having the receiving unit receive first data and first sequence information and second data and second sequence information that are transmitted from a first device to a second device, the first sequence information indicating that the first data was transmitted before the second data and the second sequence information indicating that the second data is transmitted after the first data;
having the control unit instruct the transmitting unit to transmit the first data and the second data in accordance with a sequence indicated in the first sequence information and the second sequence information.
